(19) United States
(12) Patent Application Publication
(10) Pub. No.: US 2003/0221773 A1
(43) Pub. Date: Dec. 4, 2003

(54) Apparatus and method for joining polymeric materials using an electro-magnet

(76) Inventor: Martin T. Jones, Easton, PA (US)

Correspondence Address: Bell, Boyd & Lloyd LLC, P.O. Box 1135, Chicago, IL, 60690-1135, US

(21) Appl. No.: 10/164,114

(22) Filed: Jun. 4, 2002

(51) Int. Cl. B32B 31/00; B32B 31/20; B31F 5/04; B27G 11/02; B32B 31/24; B23K 37/00; B30B 1/00

(52) U.S. Cl. 156/272.2; 156/292; 156/308.4; 156/379.6; 156/580

(57) ABSTRACT

An apparatus and method for joining layers of a web of film in a sealing machine by using magnetic force generated by one or more electro-magnets. The apparatus includes a first member and a second member that are opposite to each other. The first member includes at least one electro-magnet. The second member includes a portion thereof that is attracted to the first member. A heater and a pressure applicator are coupled to one of the first or second members. The electro-magnet is energized and moves the second member towards the first member by attracting the second member. The first member and the second member urge together while the pressure applicator forces the film layers against the heating element to heat the layers. The pressure of the first and second members joins the softened layers together and thereby seals a portion of the layers of a web of film between the first member and second members.

### BACKGROUND OF THE INVENTION

The present invention relates to apparatus for joining layers of a web of film. More specifically, the present invention relates to an apparatus for joining polymeric layers of a web of film by employing magnetic force generated by one or more electro-magnets.

Several types of machines, particularly sealing machines, utilize force to press and join layers of a web of film together. Some of these machines are manual devices, semi-automatic devices, automatic wrapping and sealing machines, fill and seal machines using pre-made bags, and form, fill and seal machines. All of these conventional machines apply force to a heatsealing member by using an actuating mechanism or similar device that is strong enough to supply the high force required to join the materials together.

These machines use several methods to press or force opposing layers of a web of film together to form a seal or seals in the layers of film. In conventional sealing machines, a pair of jaws including a heating element, close about two or more layers of a web of film. Initially, the jaws open wide to allow the layers to move between the jaws. Then, the jaws are moved towards each other using a low force until the jaws are almost together. The heating element heats the layers of the web of film while the jaws are pressed together with a large amount of force to form the seal in the web of film. The seal is cooled using a suitable cooling method and the jaws are separated to release the sealed portion of the layers. In some instances, the softened portion of the layers of a web of film adhere to the jaws and cause the jaws to stick together.

Although the conventional methods of applying a sealing force to join layers of a web of film are effective, these methods are not practical for large-scale applications or mobile applications, and are prone to breaking down due to the large forces generated by the machines.

For example in typical bag sealing machines, about fifty pounds of force per square inch of sealing surface is required to join layers of a web of film to form a seal in a bag or the like. If the machines include a seal bar that is approximately 12 inches long with a half inch wide heatsealing band on the bar, the machine has 6 square inches of sealing surface. Thus, a machine of this type produces three hundred pounds of joining force. If the sealing area is located 24 inches from the edge of a workpiece, the machine will require a member of at least 24 inches to form a seal in the sealing area. Thus, the minimum bending moment in the member is 24 inches multiplied by 300 pounds of force, or 7200 inch/pounds. These forces are transferred to the frame and other components of the machine regardless of the machines' structure. Machines having larger jaws and larger heatsealing areas require even larger forces to effect a seal. Therefore, the repeated stresses on the members and other components of the machines created by joining and sealing the layers of a web of film, especially in larger machines, are substantial and thereby, cause the machines to be massive or subject to break down.

Additionally, mechanical components in the machines are difficult to maneuver over the layers of a web of film to form a seal or seals in different locations on a workpiece, especially remote locations on the remote edges of the workpiece. The jaws or members must be extended and positioned about the portion of the layers that will be sealed and, thus, an extension member or similar device must be used to project the jaws to that location. Therefore, the machine must extend the jaws out over the layers and then position and align the jaws near the sealing portion of the layers. In this manner, positioning and aligning the jaws on each side of the layers of a web of film is difficult, time consuming and in some instances, impossible. Also, the high pressing force generated by the jaws to join layers of the web of film together is dangerous to operators of the machines because of the potential for operators to get injured by the closing jaws.

While the conventional joining and sealing machines are sufficient to form seals on layers of material, such as a web of film, the machines are difficult to position in remote locations of a workpiece, subject to failure because of the large mechanical forces applied between the sealing jaws and the bending moments on the machine members, and because of the stresses on other machine components. Moreover, most sealing machines are not practical to use for large-scale manufacturing operations and are too large to transport to remote areas.

Thus, there is a need for improved apparatus and methods for joining layers of a web of film to form seals or the like in the layers.

### SUMMARY OF THE INVENTION

The present invention provides an apparatus and method for urging and sealing two layers of a web of film together using magnetic force generated by one or more electro-magnets. The apparatus includes a first member having at least one electro-magnet and a second member that is located diametric, or opposite to, the first member. At least a portion of the second member is constructed of a material that is attracted to the electro-magnet on the first member. In one embodiment, the portion of the second member is constructed from a magnetic material such as a magnetic metal. The magnetic attraction between the first and second members urges the second member against the first member while a heater or heating element coupled to the first or second member heats the layers. As the layers are heated, the first and second members move together to join a portion of the layers of film between the first member and the second member to seal the layers. In one embodiment, the members are attached to arms that extend from the frame of a sealing machine. In another embodiment, the members are used separately, apart from any connecting framework of the machine.

In another embodiment, the apparatus includes a first member and second member where the members are diametric to each other. The first and second members each include at least one electro-magnet. The electro-magnets on the first and second members are energized to create different polarities in the electro-magnets. The different polarities of the electro-magnets of the first and second members create a mutual magnetic attraction between the members. The magnetic attraction urges the first and second members together. Once a seal is formed between the layers of film, the polarity of one of the electro-magnets on the members is reversed to repel the members away from each other. The members separate and release the sealed portion of the layers of the web of film.

In a further embodiment, the apparatus includes a first member having at least one electro-magnet and a second member opposite to the first member. The second member includes at least a portion that is constructed from a material that is attracted to the first member to urge the members together. A heater is coupled to one of the members for heating a portion of the layers while the layers are being urged together. Alternatively, one or more heaters may be coupled to the first and second member for heating the layers. A pressure applicator such as a pressure pad is coupled to a surface of one of the members for further urging the heated layers uniformly against each other and thereby forming a seal between the layers of film.

In another embodiment, the apparatus is adapted to seal a product to at least one layer of film. The product may be any product that sealed to one or more layers of film such as a fitment on a large plastic tarpaulin or a fitment on an intravenous fluid bag. The apparatus includes a first member having at least one electro-magnet and a second member diametric to the first member. The first and second members are positioned on opposite sides of the layer of film. A portion of the second member is at least partially constructed of a material so that the second member is attracted to the electro-magnet on the first member. The first and second members are formed to correspond to the shape or contour of the particular product to be sealed to the layer of film. A heater is coupled to the first or second member. The heater heats a portion of the layer of film as the first and second members urge together and join the portion of the layer of film and the product to form a seal between the product and the layer of film.

The present invention further includes a method of urging two or more layers of a web of film together. The method includes the steps of positioning a first member on one side of two layers of a web of film and a second member on another side of the layers wherein the first and second members are opposite to each other. At least one electro-magnet is attached to the first member and is energized to create a magnetic force about the first member. At least a portion of the second member is attracted to the first member to urge the members together. As the members are urged together, a portion of the layers is heated with a heater coupled to one of the members. The first and second members press the heated layers together for a predetermined amount of time to form the seal in the layers. The combination of time, heat and pressure between the first and second members forms the seal between the layers of the web of film. In an another embodiment, the heater includes a cutting edge where the heater forms a seal in the layers of the web of film and concurrently cuts the edges along the seal.

Accordingly, an advantage of the present invention is that it provides an apparatus and method for joining materials together.

Another advantage of the present invention is that it provides an apparatus that may be positioned in several locations on two or more layers of a web of film for forming seals and/or cutting the sealed edges in the layers.

A further advantage of the present invention is that it provides an apparatus that may be used in remote areas to join and seal layers of a web of film.

Still another advantage of the present invention is that it provides an apparatus that is compact and transportable.

Another advantage of the present invention is that it reduces the forces created within a sealing machine during the joining and sealing of layers of a web of film.

A further advantage of the present invention is that it provides an apparatus that includes smaller and less co-acting parts that are subject to failure.

Another advantage of the present invention is that it provides a method for joining materials together.

A further advantage of the present invention is that it provides a method for cutting materials that are joined together.

Another advantage of the present invention is that it provides an apparatus that may be used to seal products to layers of a web of film.

Still another advantage of the present invention is that it provides an apparatus for forming circular seals for joining a fitment and a material together.

A further advantage of the present invention is that it provides an apparatus that is safer for operators.

Another advantage of the present invention is that it provides an apparatus that promotes the separation of the apparatus from the sealed material and reduces the amount of sealed material that adheres to the apparatus.

A further advantage of the present invention is that it provides an apparatus that can seal products of different sizes.

Another advantage of the present invention is that it provides an apparatus that is adaptable to impulse heatsealing systems.

Additional features and advantages of the present invention are described in, and will be apparent from, the following Detailed Description of the Invention and the figures.

### BRIEF DESCRIPTION OF THE FIGURES

FIG. 1 illustrates one embodiment of the apparatus of the present invention in an open position.

FIG. 2 illustrates the apparatus of FIG. 1 in a closed position.

FIG. 3 illustrates a cross-sectional view of another embodiment of an apparatus of the present invention where a product is being sealed to a layer of film.

FIG. 4 illustrates a bottom view of the apparatus of FIG. 3.

### DETAILED DESCRIPTION OF THE INVENTION

The present invention provides improved apparatus and methods for sealing webs of film together and for sealing products to a web of film such as fitments.

Specifically, the apparatus and method employs magnetic force generated by one or more electro-magnets to move members of the apparatus together to join layers of a web of film. Using magnetic force, instead of mechanical forces, substantially reduces the stresses on the components of sealing machines and enables efficient and accurate sealing of the layers at various locations on a workpiece.

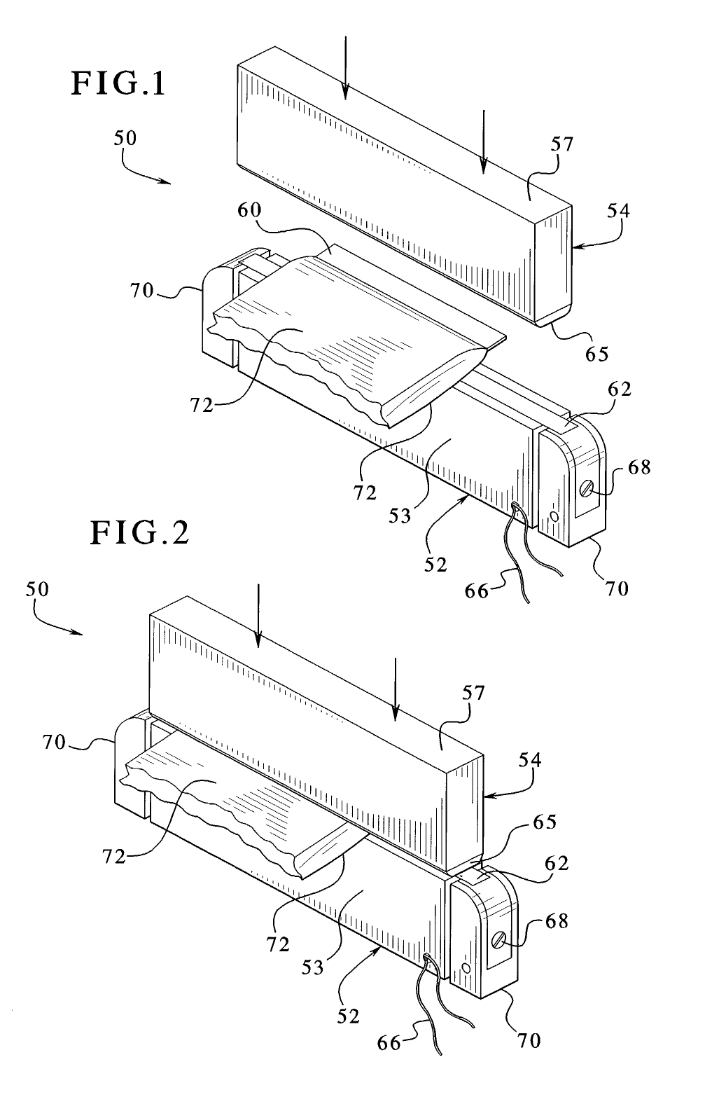

Referring to FIGS. 1 and 2, an embodiment of the apparatus 50 of the present invention is illustrated. The apparatus 50 is specifically designed for use in various types of sealing machines to join and seal layers of web of film together. The first member 52 and the second member 54 are formed into elongated rectangular bars, such as jaw bars. In this embodiment, the first member 52 includes an electro-magnet 53. Also, the first member 52 includes a heater or heating element such as heat band 62, which is coupled to the top surface of the first member 52. The heat band 62 is attached to and extends along the surface of the first member 52. It should be appreciated that the heat band or heater 62 may be coupled to the first or second member in any manner desired. In one embodiment, the heater includes a cutting edge (not shown) where the heater forms a seal in the layers of the web of film and concurrently cuts the edges along the seal. Additionally, one or more heaters may be coupled to the first and second members for heating the layers. Referring to FIG. 1, the end blocks 70 can be adjusted to increase or decrease the tension in the heat band 62 on the first member 52. The end blocks 70 are secured to the first member 52 using threaded screws 68 or other types of suitable fastening devices.

In one embodiment, the members are attached to arms (not shown) that extend from the frame of a sealing machine. In another embodiment, the members are used separately, apart from any connecting framework of the machine.

The second member 54 includes at least a portion that is attracted to the electro-magnet in the first member. What is important is that a portion of the second member 54 is attracted to the first member 52. To this end, at least a portion of the second member 54 is made of a material such as a metal, so that the second member is attracted by the magnetic force generated by the energized electro-magnet in the first member 52. More specifically, the second member 54 may be made from a highly magnetic material such as a soft iron. Additionally, the distance between the first and second members is inversely proportional to the strength of the magnetic force between the members. The closer the members, the greater the magnetic force. Thus, the magnetic force generated by the first member 52 must be sufficient to attract the second member 54 based on the distance between the first member and second member and the size of the electro-magnet in the first member 52.

A pressure applicator or pad 65 is coupled to and extends along the bottom surface of the second member 54. The pressure pad 65 may be made of any durable material that is suitable for joining and heatsealing one or more film layers together. The electrical wires 66 transfer electricity from an electrical source through wires (not shown) inside the first member 52, which energizes the electro-magnet 53 and heat band 62 on the first member. The first member 52 and the second member 54 are preferably attached to arms, which extend from the frame of the machine, and position the first member and second member about a desired heatseal portion. It should be appreciated, however, that little or no frame may be used or attached to the first and second members so that the first and second members may be positioned at remote or outer edges of a material work piece without any connective framework. The lack of a frame also diminishes the amount of stress transferred to the other components of the machine such as the arms and frame.

Referring to FIG. 1, the first member 52 and the second member 54 are positioned on each side of the layers of a web of film 72. Once the first member 52 is positioned below the lower layer of film, the second member 54 is positioned over the top layer of film and aligned with the first member. In conventional sealing machines, the jaws or members must be aligned perfectly or a seal may not be formed correctly. This is particularly problematic when forming a seal on a large workpiece such as a tarpaulin for a large tent or canopy, where the alignment of the large jaws is extremely difficult and time-consuming. With the apparatus 50 of the present invention, however, the magnetic attraction between the first and second members 52 and 54, pull each member into alignment with the other member and thereby eliminates the need to manually align the members about a seal. The alignment feature of the apparatus 50 saves time and therefore, increases production efficiency. Initially, the first and second members 52 and 54 are aligned in general proximity to each other because the alignment feature described above corrects the alignment of the members as the members are pulled closer together. Only a low magnetic force is required to move the members closer together. It should be appreciated that the members may be moved closer together manually, mechanically or using any other suitable method.

When the first and second members 52 and 54 are substantially together or very near each other the heat band or heater 62 is heated to a predetermined temperature to heat and soften the layers of the web of film 72. At about the same time, the electro-magnet in the first member 52 is energized and creates the magnetic force that causes the sealing pressure between the members. The pressure pad 65 on the bottom surface of the second member 54 urges or pushes the top layer of film uniformly against the bottom layer of film and against the heater 62 as shown in FIG. 2. The pressure between the first and second members along with the heat generated by the heater 62 forms the seal 60 on a portion of the layers of a web of film.

In FIG. 1, the heatseal 60 is formed at one end of the layers of film 72 and forms a pouch or bag. Once the seal is formed and cooled, the first member 52 and the second member 54 are separated to release the heatsealed portion of the layers of film from between the first and second members (as shown in FIG. 1). The first and second members may be separated by reversing the flow of electricity, or reversing the polarity, in the electro-magnet 53 causing the electro-magnet to repel the magnetic material 57 of the second member 54. The repelling force between the first and second members causes the members to separate. Once the members are separated, the heatsealed portion of the layers is removed and transported for further processing on the sealing machine.

In the embodiment illustrated in FIGS. 1 and 2, the elongated bar-shaped members 52 and 54 may form any size or length of elongated seal on the layers of a web of film by manufacturing different sizes of members to seal the layers. In another embodiment described in more detail below, the members 52 and 54 may be completely separate from a machine or support frame. In this embodiment, the first and second members 52 and 54 can be placed at any location on the layers of a web of film to form a seal or seals. By eliminating the need for extended framework or large apparatuses such as arms to position the members about a portion or portions of the layers, the apparatus 50 enables a manufacturer to form heatseals at remote locations or distant edges on a material workpiece that would normally be difficult or impossible to reach using conventional machines. The lack of an extended framework also reduces the substantial stresses and wear placed on the machines due to the high mechanical forces and bending moments transferred from the mechanical members, or jaws, to other components in the machines.

In a further embodiment, an electro-magnet 53 is included or attached to both the first member 52 and the second member 54. In this embodiment, both electro-magnets can be energized and produce a stronger magnetic force between the members. The strong magnetic attraction may be accomplished by flowing electricity in one direction in one electro-magnet, and flowing the electricity in the opposite direction in the other electro-magnet (i.e. creating two different polarities). Similarly, the electro-magnets may be repelled by flowing the electricity in the same direction in both electro-magnets. An apparatus 50 having electro-magnets 53 coupled to one or both members, generates more instantaneous force or pressure to form heatseals in layers of a web of film and enables an operator to have greater control over the members.

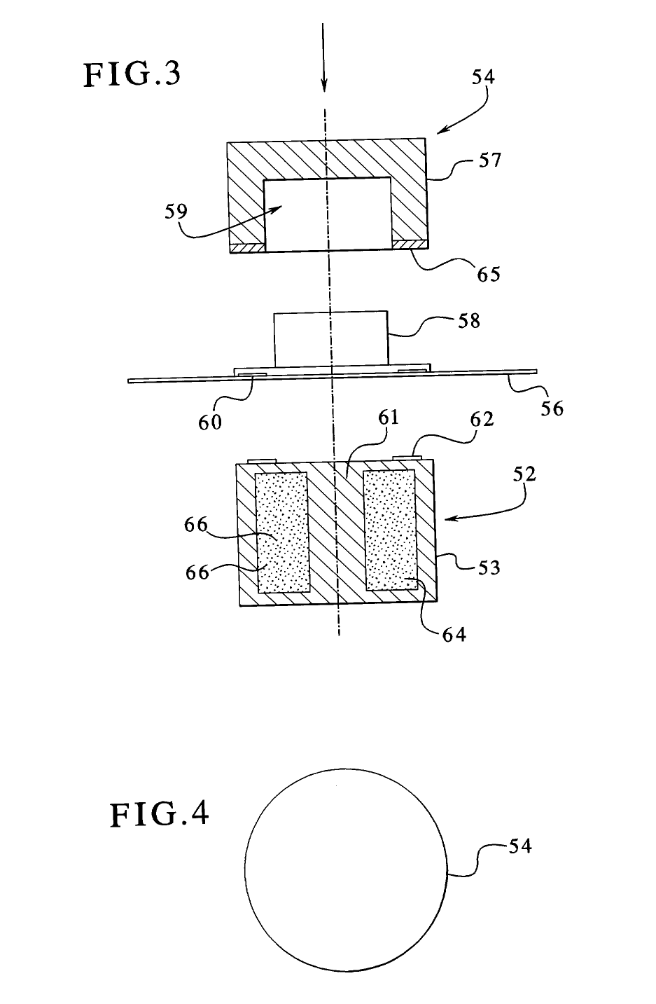

The apparatus 50 may also be used to seal a product to a web of film. In FIGS. 3 and 4, one type of product, a fitment, is sealed to a layer of a web of film. The apparatus 50 includes a first member 52 that includes a heater or heating member 62, and a second member 54. The first member 52 includes an electro-magnet that creates a magnetic force when energized by an electrical source. As described in detail below, the electro-magnet in the first member 52 is energized and creates a magnetic force, which attracts a portion of the second member 54. The magnetic attraction pulls or attracts the second member 54 towards the first member 52 and the pressure created between the two members presses and joins two or more layers of film 56, or joins a product, such as fitment 58, to one of more layers of film 56 as shown in FIG. 3.

The heater 62 functions to apply a predetermined amount of heat to the layers of a web of film 56 to heatseal the layers as the first member 52 and second member 54 close together. The portion of the second member that is attracted to the first member, is preferably a material such as a metal that is attracted by a magnetic field. It should be appreciated that the attracted portion may be manufactured with any material that is attracted to a magnet.

As illustrated in FIGS. 3 and 4, the first member 52 and the second member 54 are located on opposite sides of the layers of film 56, diametric or opposite to each other. The first member 52 includes an electro-magnet and creates a magnetic field or force when it is energized by an electrical source. In this embodiment, the first member 52 is cylindrical shaped, however, it is should be appreciated that the first member 52 may be any shape or size based on the particular type of seal to be formed.

The electro-magnet 53 includes a housing that may be made of metal or other durable material and electrical coils 64. The electrical coils 64 include a plurality of wires that are wound around a center post or shaft 61 in the middle of the first member 52. The electrical coils 64 are connected to electrical wires 66, which transfer electricity from an electrical power source (not shown) to the electrical coils 64. The wires that form the electrical coils 64 are preferably made of a conductive material such as copper, which will efficiently transfer the electricity through the coils. The first member 52 is also coupled to a heater 62, which supplies a predetermined amount of heat to form a seal or seals in the layers of film or between the fitment and the layer of film.

The second member 54 is attracted to the first member and urges the top layer of a web of film against a bottom layer to form a seal in the layers of a web of film. A pressure applicator such as pressure pad 65 is coupled to the bottom surface of the second member 54 to further urge or push the layers of a web of film against the heater 62. Additionally, the second member 54 is cylindrically shaped to correspond to the shape of the first member 52. In the illustrated embodiment, the first member 52 and the second member 54 are cylindrically shaped to fit about the fitment 58, mainly used in pharmaceutical applications and products, to seal the base of the fitment to the layers of film 56. However, it should be noted that the first member 52 and the second member 54 may be manufactured into any size or shape to correspond to different size products.

The pressure applicator or pressure pad 65 on the second member 54 is made of a resilient material such as a heat resistant silicone rubber which pushes or presses the fringe portion of the fitment 58 into the layers of film 56 to form the seal between the fitment and the layer of film.

In operation, the first member 52 is positioned under the layers of film 56. The second member 54 is positioned above the product, i.e. fitment 58, and aligned with the position of the first member 52. The cylindrical first and second members 52 and 54 may also form circular heatseals on two or more layers of film. As illustrated in FIG. 3, the second member 54 has a receptacle 59, which is formed in the second member 54, to receive a fitment 58. A receptacle 59 is formed to correspond to the size of the fitment 58. It should be appreciated that the receptacle 59 may be formed into any size or shape to correspond to different size products such as fitments 58. Once the second member 54 is positioned over the fitment 58 and the first member 52 is positioned underneath the layers of film 56, which is below the fitment 58, the machine begins the process of forming a seal between the fitment 58 and the layers of film 56.

Preferably, the first member 52 is an electro-magnet as shown in FIG. 3. The electro-magnet, however, may also be positioned near or attached to the first member 52 to attract the second member in a similar manner. When the first member 52 is in position, the electro-magnet is energized by an electrical source. The electricity travels through the coils 64 in the electro-magnet 53 and creates a magnetic field or force about the coils. The magnetic force, or magnetic flux, is created by passing electricity through the coils 64. The force is perpendicular to the wires, or to the flow of electricity through the wires, that form the coils 64. Therefore, the magnetic force generated by the electro-magnet may be increased by increasing the number of coils 64 that form the electro-magnet. The greater the number of coils in the electro-magnet, the greater the magnetic force or flux.

In this embodiment, the magnetic force generated by the energized coils 64 in the first member 52 attracts the second member 54. Initially, the electro-magnet 53 in the first member 52 is energized with electricity and attracts the second member 54 towards the first member. Once the first and second members 52 and 54 are near the desired seal area and almost together, the electro-magnet 53 is de-energized momentarily.

The heater 62 on the first member 52 is heated to a predetermined temperature. The heat generated by the heater 62 starts to soften the layers of film 56 so that the base of the fitment 58 adheres to the softened layers of film 56. As illustrated in FIG. 3, the heating member 62 is coupled to the first member 52 so that the heating member only contacts the area or portion of the layers of film 56 where the seal is to be formed.

Once the heater or heating member 62 softens the layers of film 56, the electro-magnet in the first member 52 is concurrently re-energized to pull the first and second members together. At this stage, the electro-magnet 53 in the first member 52 generates a substantial amount of force by passing larger amounts of electricity through the coils 64. The greater force is needed to firmly press the base of the fitment 58 against the softened layers of film 56 at the seal point. The strong magnetic force between the first and second members 52 and 54, significantly increases the attraction between the first member 52 and the second member 54. Therefore, the second member 54 pushes down or presses down with a greater force on the base of the fitment 58 to form the seal. The pressure pad 65 located on the bottom surface of the second member 54 promotes or urges the base of the fitment to the layer of film 56. The force of the second member 54 against the base of the fitment 58 causes the softened circular portion of the layers of film 56 to form a circular heatseal 60 between the base of the fitment 58 and the layers of film.

After the circular heatseal 60 is formed between the fitment 58 and the layers of film 56, the heating member 62 cools down as the first member 52 and second member 54 remain together. After a predetermined amount of time, when the seals have had a sufficient time to form and cool, the first member 52 and the second member 54 are moved apart or separated to release the layers of film 56 from between the members. The sealed fitment and associated layers of film are transported to a different area of the machine for further processing.

Typically in conventional sealing machines, the layers of film 56 tend to stick or adhere to the surfaces of the first and second members 52 and 54. The layers of film 56 and particularly, the heatseal 60 on the layers of film, sticks to the members of the heatsealing machine. As a result, the members become difficult to separate and the heatseal may destroyed or weakened. This is particularly problematic in pharmaceutical applications and products where the seals are critical to sterilization.

In the present invention, the tackiness or adhesion of the layers of film 56 to the first and second members 52 and 54 may be overcome by reversing the polarity of the electro-magnet or reversing the flow of electricity in the electro-magnet 53 in the first member 52. By reversing the flow of electricity in the electro-magnet 53, the electro-magnet repels or pushes away the magnetic material 57 of the second member 54. Therefore, the repelling force produced by the electro-magnet helps to separate the first member and second member from the heatseal areas of the layers of film 56. Depending on the size of the heatseal portions of the layers of film, the flow of electricity may be increased or decreased to vary the force of separation between the first and second members 52 and 54, respectively.

Although, the first member 52 preferably includes one electro-magnet, the first member 52 may include a plurality of electro-magnets depending the amount of magnetic force that is needed to form a heatseal in two or more layers of a web of film 56. The number and size of the electro-magnets in the first member 52 will depend on the number and size of the heatseals that will be formed in the layers of a web of film. In another embodiment described in detail below, both the first and second members 52 and 54 include electro-magnets to provide more control over the attraction and separation of the members.

In another embodiment, the apparatus 50 is portable so that it may be used in remote locations where energy sources or electrical sources are limited or where seals must be made on a very large workpiece. In this embodiment, the first member 52 and the second member 54 are not attached to frame or machine. Instead the first and second members 52 and 54 are separate components that can be individually positioned on each side of two or more layers of a web of film. Therefore, the first and second members may be transported and used at remote locations.

The electro-magnet can be energized by portable battery packs or outlets in automotive vehicles. The electrical wire 66 or electrical cord may be plugged into the energy source to energize the electro-magnet. Therefore, the first and second 52 and 54 may be positioned about layers of a web of film in remote locations by manually placing the members next to the film layers. Then the first member 52 may be energized by plugging the electrical cord or wire 66 into the electrical source. The energized electro-magnet in the first member 52 attracts the second member 54, which is placed on the opposite side of the layers of a web of film and over the first member 52. One example of where this embodiment is useful is where plastic tubing used for agricultural irrigation must be repaired in the middle of a farm or field. The electro-magnet is plugged into a portable electric source such as a battery pack and used to form the repair seal in the tubing. In another example, the apparatus and method can be used to repair large workpieces, such as parachutes or tents.

In a further embodiment, the apparatus 50 may be energized and de-energized intermittently to enable the apparatus to be used in impulse heatsealing systems. The momentary application of force created by the energized electro-magnet in the first member can be readily timed to be in synchronization with the momentary application of power needed to form a seal in this type of system. Furthermore, the apparatus 50 may be energized and de-energized to open and close the first and second members so that the layer of film or layers of film may be fed through the members in an assembly line. The opening and closing of the members can be adjusted to accommodate the number of seals that need to be formed on the layers of a web of film and the number of bags or containers that need to be made. Furthermore, the apparatus can be energized or de-energized instantaneously, thereby increasing the speed and efficiency of the machine. This type of application is particularly useful when mass quantity of bags or pouches are being made such as in a large-scale manufacturing operation.

In another embodiment, a large electro-magnet may be used for larger industrial applications. In this embodiment, the first member 52 and the second member 54 may be raised and positioned by using either a large crane, hot air balloon or other similar types of lifting devices. Once the members are positioned about the layers of a web of film, the electro-magnet is energized to close the members together and form the seal. In this type of application, the ability of the electro-magnet to be energized and de-energized becomes more important, because of the size and pressure forces created by the larger mechanical-type apparatus.

In another embodiment, the apparatus 50 may be used in heatsealing machines that require prolonged heating to form seals in layers of a web of film. In this embodiment, a heat sink, circular air, or cooling water is used to cool the heating member on the first or second member while maintaining the maximum magnetic force needed to press or push the layers of a web of film together. The cooling effect enables the heatseal to cool down and form quickly, and thereby enables more seals to be formed on a layer of film or on several layers of a web of film.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An apparatus for urging two or more layers of a web of film together comprising:
a first member including at least one electro-magnet;
a second member diametric to said first member, said second member including a portion thereof that is attracted to the electro-magnet; and
a heater coupled to said first or second member wherein said heater heats a portion of the layers of the web of film as said first and second members urge the layers together to form a seal in the layers.

2. The apparatus of claim 1, wherein the attracted portion is constructed from a metallic material.

3. The apparatus of claim 2, wherein the material is iron.

4. The apparatus of claim 1, which includes a plurality of heaters wherein at least one of said heaters is coupled to each of said first and second members for heating a portion of the layers of film.

5. The apparatus of claim 1, wherein said heater is integral to one of said first and second members.

6. The apparatus of claim 4, wherein the heater is a heat band extending along a surface of one of said members.

7. The apparatus of claim 1, wherein said first member includes a plurality of electro-magnets.

8. The apparatus of claim 1, wherein the second member includes an electro-magnet for creating a mutual magnetic attraction with the electro-magnet on said first member, for urging said first and second members together, and for repelling said electro-magnet on said first member after a seal is formed between the layers of the web of film.

9. The apparatus of claim 1, including a cutting device for severing the layers of the web of film.

10. The apparatus of claim 1, including a pressure applicator coupled to a surface of one of said first or second members for urging the layers of the web of film against one of said members.

11. An apparatus for sealing two or more layers of a web of film together comprising:
a first member including at least one electro-magnet;
a heater coupled to said first or second member for heating the layers; and
a second member diametric to said first member, said second member including at least one electro-magnet for creating a mutual magnetic attraction with the electro-magnet on said first member to urge said first and second members together and for repelling said electro-magnet on said first member after a seal is formed between the layers of the web of film.

12. The apparatus of claim 11, which includes a plurality of heaters wherein at least one of said heaters is coupled to each of said first and second members for heating a portion of the layers of film.

13. An apparatus for sealing two layers of plastic together comprising:
a first member including at least one electro-magnet;
a second member diametric to said first member, said second member including a portion thereof that is attracted to said electro-magnet for urging the second member towards the first member; and
at least one of the members includes a device for sealing a portion of the layers between the first member and the second member.

14. The apparatus of claim 13, wherein the device for sealing is a heating element.

15. An apparatus for sealing two or more layers of a web of film comprising:
a first arm and a second arm;
a first member including an electro-magnet attached to said first arm;
a second member opposite said first member and attached to said second arm, said second member including a portion thereof that is attracted to said first member for urging said arms and members together;
a heating element coupled to the first or second member for heating a portion of the layers; and
a surface of one of said members including a pressure applicator for urging the layers against each other to form a seal in the layers.

16. An apparatus for sealing a product to at least one layer of film comprising:
a first member including at least one electro-magnet; and
a second member diametric to said first member, said second member including a portion thereof that is attracted to said electro-magnet on said first member;
a heater coupled to said first or second member for heating a portion of at least one layer; and
at least one of the first or second members including an area for receiving a portion of the product.

17. The apparatus of claim 16, wherein the product is a fitment.

18. A method of sealing two or more layers of a web of film together, comprising the steps of:
(a) placing a web of film having a first and second layer between a first member and a second member;
(b) energizing at least one electro-magnet included in said first member to create a magnetic force about the first member;
(c) attracting the second member towards the first member; and
(d) heating a portion of the layers as said first and second members urge together causing said layers of the web of film to join together to form a seal in the layers.

19. The method of claim 18, which includes the step of promoting the urging of the layers of film with a pressure applicator coupled to said first or second member.

20. The method of claim 18, which includes the step of energizing at least one electro-magnet included in said second member to create a mutual magnetic force between said first and second members.
